(19) United States
(12) Patent Application Publication
(10) Pub. No.: US 2017/0302020 A1
(43) Pub. Date: Oct. 19, 2017

(54) Gator Shield

(71) Applicants: Samuel James Darling, Muskegon, MI (US); Christopher Allen Ritter, Whitehall, MI (US)

(72) Inventors: Samuel James Darling, Muskegon, MI (US); Christopher Allen Ritter, Whitehall, MI (US)

(21) Appl. No.: 14/730,275

(22) Filed: Jun. 4, 2015

(51) Int. Cl. H01R 13/53; H01R 11/24; H01R 13/46; H01R 13/641

(52) U.S. Cl. CPC H01R 13/53; H01R 13/641; H01R 11/24; H01R 13/465

(57) ABSTRACT

The Gator Shield is a new product that encapsulates alligator clips and provides finger safe quick connection to distribute power. The Gator Shield secures alligator clips in an electrically insulated housing. The alligator clips are recessed into the housing at a distance to provide a finger safe product. It includes a visual power alert attached to the housing to indicate power to alligator clips. Alligator clip actuation is done through an electrically insulated button. Button color may vary depending on local electrical code and/or customer preference. Housing may or may not be marked with various markings indicating an alpha numeric code (See FIGS. 2, 3 and 5).

Electrical shock is a common hazard in the workplace today. Electrical shock can be attributed to many sources. Even though alligator clips remain one of the most common ways of testing and providing temporary power connection, power distributed through alligator clips are a hazard, in an electrical sense, to use.

The invention relates to alligator clips and more particularly to an object encapsulating the clips.

Alligator clips in themselves are a conductive material which a wire attaches to make the clip part of the electrical path. This clip is then clipped to a temporary wire to transmit power to the operators' circuit. The clip provides a quick way of disconnecting and reconnecting the power. The conductive surface of most alligator clips is fully exposed. Few alligator clips have a rubber shroud to cover a large percentage of the exposed conductive surface. Even these protective sleeves can slide up the wire, as they are not attached leaving the operator exposed to potentially fatal electricity. When multiple alligator clips are incorporated to connect a circuit, another hazard present would be the clips touching one another, creating an arc flash. The operator, in addition, is tasked with identifying which clip correctly connects to the temporary wires. Alligator clips used on the ends of wires are not in a fixed location or order. Mistakes can be made by operators incorrectly connecting the alligator clips creating an arc flash hazard.

The Gator Shield incorporates the alligator clips that are widely used as temporary connection of power. The principal object of this invention creates a safe environment by allowing the operator to identify and operate the alligator clips without risk of touching the uninsulated surface which connects to the wire. Another object of the invention is to prevent alligator clips from touching each other when multiple are used to connect the electric circuit. Another object of the invention is to allow the operator to know when power is present at the alligator clips ensuring it is safe to operate the clips and disconnect/connect the circuit.

The Gator Shield encloses alligator clips in an electrically insulated housing. The invention also keeps the alligator clips secure, permanently identified and separated. The invention causes the alligator clips to be finger safe to the operator. In addition, the invention indicates to the operator when power is applied to the alligator clips.

### DESCRIPTION OF DRAWINGS

FIG. 1: The base in which the alligator clips are inserted

FIG. 2: The cover which encloses the alligator clips and buttons

FIG. 3: Second cover showing labelling of clips can vary

FIG. 4: Operator buttons which actuate the alligator clips safely

FIG. 5: Assembly of final product

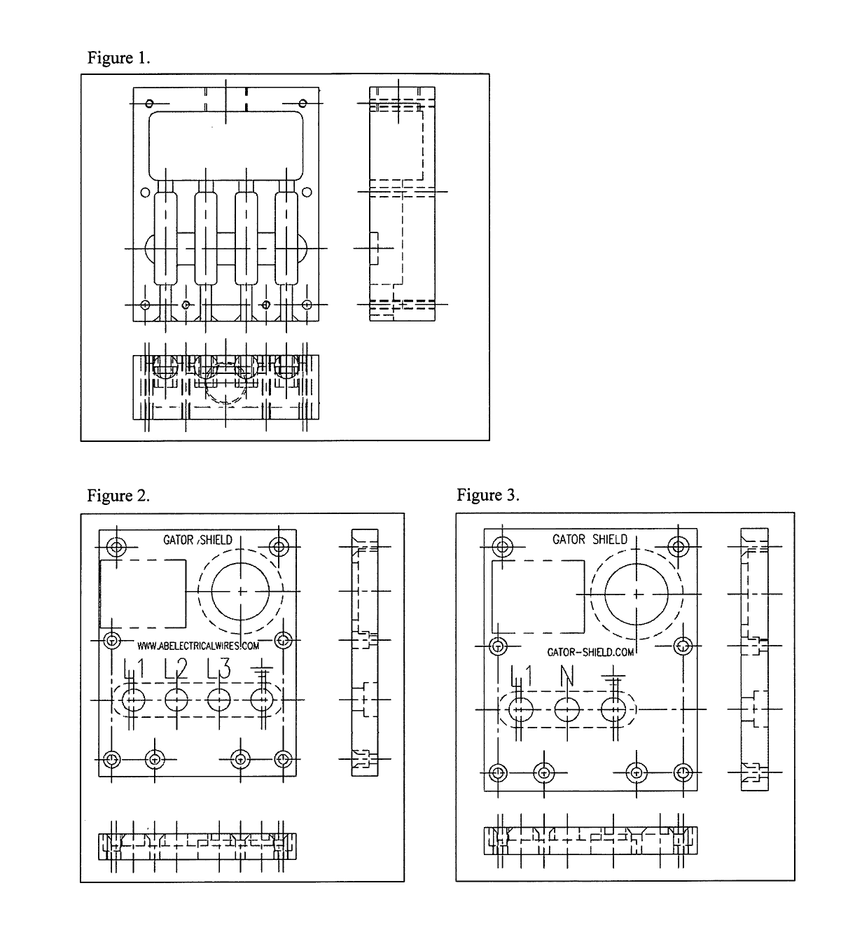

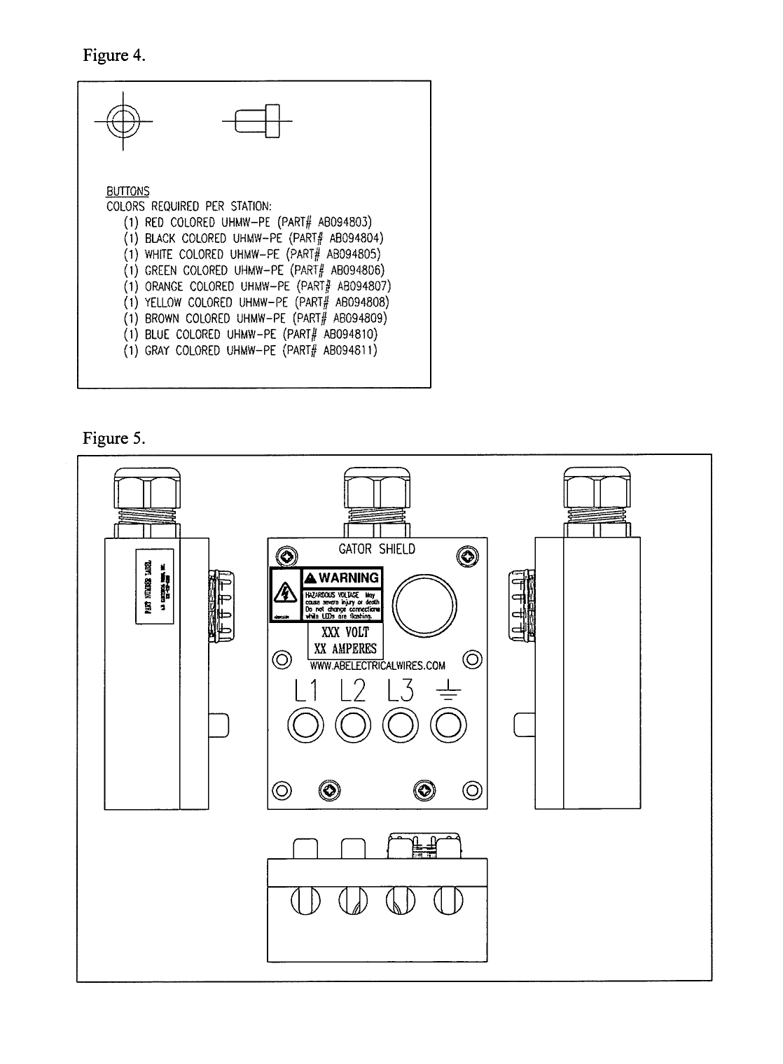

The Gator Shield is manufactured from an electrically insulated material. Alligator clips are inserted into a cavity that is machined out of insulated material (FIG. 1). Enough material is left between the clip and edge of product to ensure the rated voltage of the product is non-conductive on the surface. In addition, enough material exists between the alligator clips to ensure, at the rated voltage, the hazard of arcing between the alligator clips remains absent. Buttons (FIG. 4) composed of non-conductive material are incorporated into the invention for the operator to actuate the alligator clips. A cover is placed over the base that confines the alligator clips and buttons. After the cover is assembled to the base the only openings in the invention are wire tunnels to the alligator clips (See FIG. 5). The tunnels are long and small enough that fmgers can not touch the uninsulated surface of the clip. Multiple covers (FIG. 2 and FIG. 3) and colored button combinations are available to aid the operator in identification of each alligator clip. Each cover is made of a transparent material. The operator can observe inserting a wire into the wire tunnel and establishing a connection to the alligator clip through the cover. A power alert indicator mounted to the cover indicates to the operator that voltage is present at the alligator clips. The indicator connected directly to the clips will indicate voltage present whether the voltage is supplied from the Gator Shield or back fed from the connected circuit. The operator can recognize then when it is safe to attach or remove wires when the indicator confirms power not being present at the alligator clips.

1: A power distribution device comprising:
One or more alligator clips;
Housing;
Buttons;
Power indicator;
